(19) United States
(12) Patent Application Publication
(10) Pub. No.: US 2008/0130083 A1
(43) Pub. Date: Jun. 5, 2008

(54) Drive apparatus for an optical modulator with a ternary drive signal, optical transmitter, and optical transmission system

(75) Inventor: Shuichi Yasuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/998,456

(22) Filed: Nov. 30, 2007

(30) Foreign Application Priority Data
Dec. 1, 2006 (JP) 2006-325590

(51) Int. Cl. G02B 26/00

(52) U.S. Cl. 359/238

(57) ABSTRACT

A drive apparatus for an optical modulator is provided with a signal supplying unit which supplies a ternary drive signal to the optical modulator; an amplitude adjusting unit which modulates an amplitude of the ternary drive signal based on a sub-signal, the frequency of the sub-signal being different from the frequency of the ternary drive signal, and; a detection unit which detects the intensity of an output light output from the optical modulator. The amplitude adjusting unit changes the amplitude of the ternary drive signal based on a level of the sub-signal in the output of the detection unit.

The present invention claims foreign priority to Japanese application 2006-325590, filed on Dec. 1, 2006, which is incorporated herein by reference in its entirety.

### FIELD OF THE INVENTION

The present invention relates to a technique for modulating light in optical communication.

### DESCRIPTION OF RELATED ART

In recent years, in proportion to an increase in the volume of information traffic, an optical communication system capable of large volume communication and long distance communication has been desired.

As an electro-optic converter circuit in an optical communication system, an intensity modulation-direct detection scheme (a direct modulation scheme) is the simplest scheme. This scheme turns on/off a current driving a semiconductor laser depending on “0” or “1”, to control light-emission/extinction. However, when the laser itself is directly turned on/off, wavelength variation (chirping) is generated in the signal light due to the nature of the laser as a semiconductor. The faster a data transmission speed (bit rate) becomes, the worse the wavelength variation adversely affects the laser. This is because an optical fiber has characteristics in which propagation speed varies depending on the wavelengths of the light propagating, which is the nature of wavelength dispersion. When wavelength variation occurs due to the direct modulation scheme, a propagation speed is lowered, and a waveform of the propagating light is distorted during propagation in the optical fiber. As a result, transmissions over a long-distance and high-speed transmission become difficult.

In order to suppress the influence of the wavelength variation, in high-speed transmissions of 2.5 Gbps and 10 Gbps, an external modulation scheme is commonly used. Thus modulation scheme includes a laser diode continuously emitting light and an external modulator turning on (transmitting)/off (blocking) the emitted light whether a data signal is depending on “1” or “0”.

As an external modulator, a Mach-Zehnder optical modulator (MZ optical modulator or MZ modulator) is commonly used. FIG. 5 is a schematic diagram of a Mach-Zehnder optical modulator.

In the MZ modulator of FIG. 5, input light waveguide 1A branches a light from a light source (semiconductor laser) 2 in two. Branched light waveguides 1B and 1C guide the branched signal lights. An output light waveguide 1D combines the signal lights from the branched light waveguides 1B and 1C. These waveguides 1B and 1C are formed on a transparent LiNbO₃ substrate. Also, in the MZ modulator 1, electrodes 11 and 12 are formed in the MZ modulator 1 and apply phase modulation to the lights guided by the branched light waveguides 1B and 1C.

In the MZ modulator 1, when a voltage is applied to the electrodes 11 or 12, the refractive indexes of the branched light waveguides 1B or 1C change due to an electro-optic effect. For this reason, by applying the drive signals to the electrodes 11 and 12, you can make the refractive indexes different for the branched light waveguides 1B and 1C.

In this manner, the MZ modulator 1 generates a phase difference between lights passing through the branched light waveguides 1B and 1C and performs a phase modulation. For example, when a data signal is “0”, a phase difference between the signal lights of the branched light waveguides 1B and 1C is 180°. When the data signal is “1”, a phase difference between the optical signals of the branched light waveguides 1B and 1C is 0°.

The phase-modulated lights from the branched light waveguides 1B and 1C are combined and output from the output optical waveguide 1D. When the phase difference of the lights from the branched waveguides 1B and 1C is 0°, the lights are combined and output from the output optical waveguide 1D. When the phase difference of the lights from the branched waveguides 1B and 1C is 180°, the lights are canceled out, so there is no output from the output optical waveguide 1D.

As the MZ modulator 1 modulates alight by blocking or transmitting the continuously emitted light in this manner, wavelength variation of the output signal light is advantageously small.

Prior art techniques are disclosed in Japanese Patent Application Laid-Open (JP-A) No. 8-179390 and U.S. Pat. No. 5,798,857.

In order to superpose a sub-signal with a light output (signal light) in an optical transmitting apparatus using the external modulator as described above, a scheme which modulates a driving current for a light source has been proposed.

FIG. 6 is a schematic diagram of an optical transmission apparatus which superposes a sub-signal. An optical transmission apparatus 90 inputs light from a light source 2 to the external modulator 1 through an optical fiber 3 to modulate the intensity of the incident light and then output the signal light.

In this case, a modulator drive circuit 94 inputs a drive signal depending on a main signal to the external modulator 1 and thereby causes the external modulator 1 to perform modulation based on a main signal.

A light source drive circuit 95 performs amplitude modulation for a driving current of the light source 2 depending on the sub-signal. In this manner, the intensity of light output from the light source 2 is modulated to combine the main signal with the sub-signal.

However, by modulating the driving current of the light source 2, wavelength variation is generated as in the direct modulation scheme, and transmission (dispersion) characteristic are deteriorated.

Furthermore, the greater the amount of modulation of the driving current of the light source become, the greater the amount of wavelength variation tends to be generated. Accordingly, a superposing ratio of a sub-signal is disadvantageously limited.

### SUMMARY

A drive apparatus for an optical modulator is provided with a signal supplying unit which supplies a ternary drive signal to the optical modulator; an amplitude adjusting unit which modulates an amplitude of the ternary drive signal based on a sub-signal, the frequency of the sub-signal being different from the frequency of the ternary drive signal, and; a detection unit which detects the intensity of an output light output from the optical modulator. The amplitude adjusting unit changes the amplitude of the ternary drive signal based on a level of the sub-signal in the output of the detection unit.

### DESCRIPTION OF THE DRAWINGS

FIG. 1 is a schematic diagram of an optical transmission apparatus of the present embodiments.

FIG. 2 shows a duobinary scheme used by the signal supply unit to drive the external modulator.

FIGS. 3a-3c is views showing the way of bias level adjustment and drive signal amplitude adjustment.

FIG. 4 is a view showing the way of bias level adjustment and drive signal amplitude adjustment.

FIG. 5 is a view showing an external modulator.

FIG. 6 is a schematic diagram of an optical transmission apparatus which superposes a sub-signal to output light of a light source.

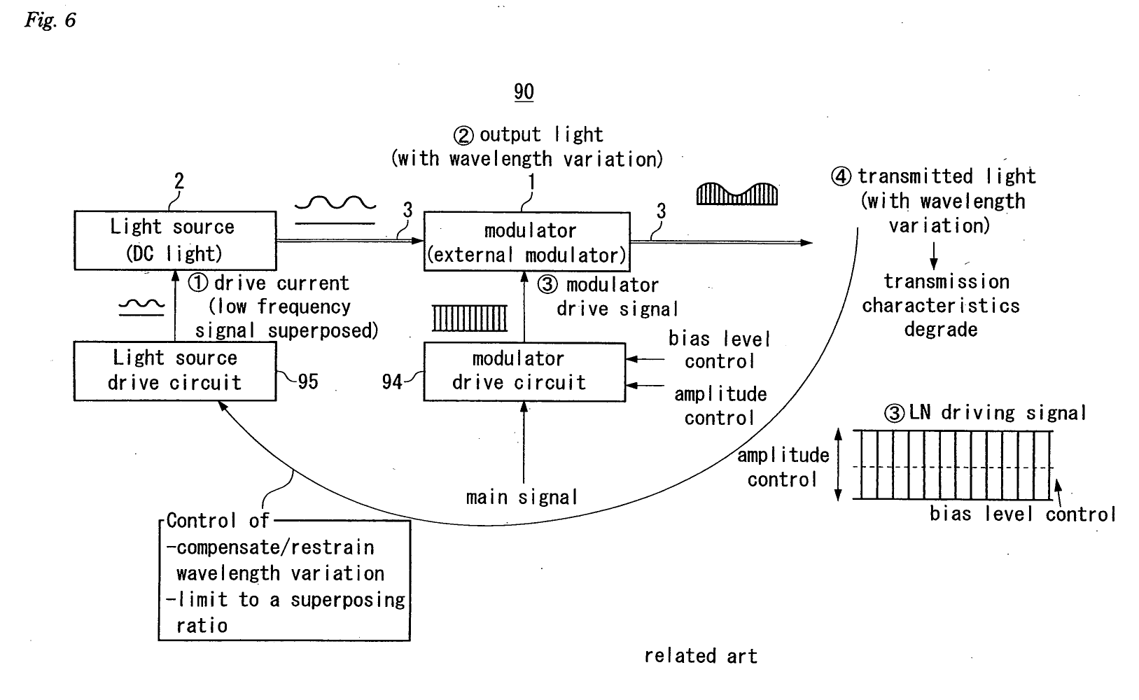

### DETAILED DESCRIPTION OF THE PREFERRED EMBODIMENT

Reference will now be made in detail to embodiments of the present invention, examples of which are illustrated in the accompanying drawings, wherein like reference numerals refer to like elements throughout.

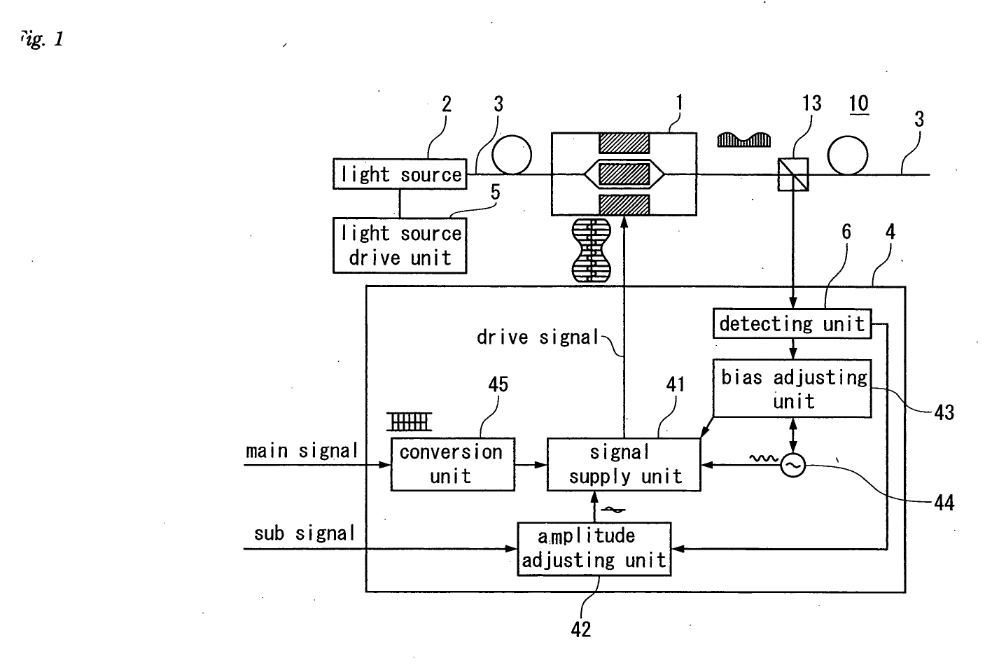

FIG. 1 is a schematic diagram of an optical transmission apparatus of the present embodiments. A light source 2, for example, a semiconductor laser, is driven by a light source drive unit 5 The light from the light source 2 transmitted is propagated through an optical fiber 3 and an external modulator 1 modulates the light from the light source 2. A modulator drive unit (corresponding to a drive apparatus) 4 drives the external modulator 1. Splitter 13 splits a part of a signal light modulated by the external modulator 1 and detecting unit 6 detects a light intensity of the signal light and outputs a detected signal as an electric signal (feedback signal).

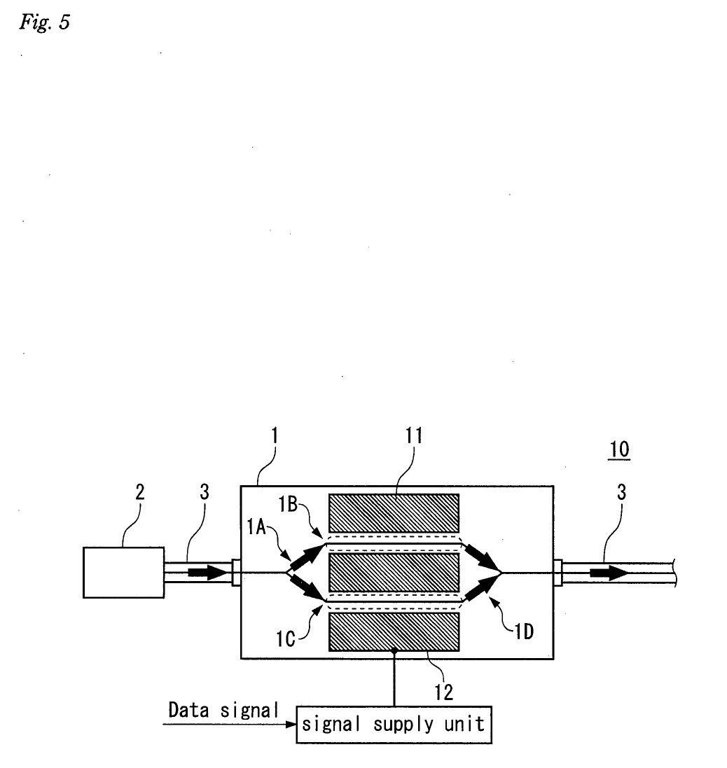

In the external modulator 1, as shown in FIG. 5, optical waveguides 1A to 1D and electrodes 11 and 12 are formed on a substrate having an electric-optic effect. The substrate having the electric-optic effect may be composed of, for example, lithium niobate, lithium tantalate, PLZT (lead lanthanum zirconate titanate), or a quartz-based material.

An optical waveguide on the substrate can be formed by diffusing Ti or the like on a substrate surface by a thermal diffusion method, a proton exchange method, or the like. The control electrodes 11 and 12 can be formed by an electrode pattern forming of Ti and Au, a gold-plating method, or the like. A buffer layer composed of a dielectric material such as SiO₂ may also be formed on the substrate surface after the optical waveguide is formed as needed.

The modulator drive unit 4 also includes a signal supply unit 41, an amplitude adjusting unit 42, a bias adjusting unit 43, an oscillator 44, and a converter unit 45. The signal supply unit 41 amplifies and supplies the main signal to the external modulator 1 as a drive signal. The amplitude adjusting unit 42 adjusts amplitude of the drive signal supplied by the signal supply unit 41. The bias adjusting unit 43 performs ABC (Automatic bias control) control by bias level adjustment of the drive signal through the signal supply unit 41. The oscillator 44 supplies a control signal for the ABC control to the bias adjusting unit 43. The converter unit 45 converts the main signal.

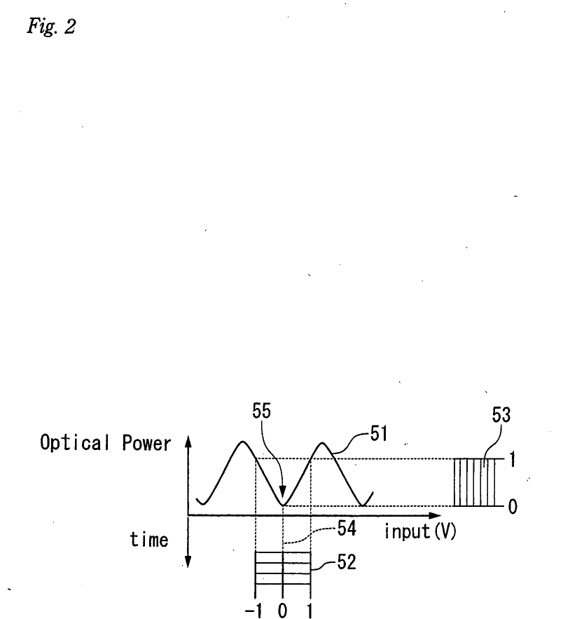

FIG. 2 shows the duobinary scheme used by the signal supply unit 41 to drive the external modulator 1. The graph in FIG. 2 shows a modulation curve 51 of the external modulator 1, where the horizontal axis indicates voltages of drive signals applied to the control electrodes 11 and 12 of the external modulator 1, and the vertical axis indicates an intensity of an output light obtained when the voltages are applied. When a drive signal 52 is applied to the external modulator 1, a signal light 53 is output.

In this embodiment, the converter unit 45 converts an input main signal from a binary signal (for example, 1, 0, 1) to a ternary signal (for example −1, 0, 1) to perform the duobinary modulation. The signal supply unit 41 amplifies the ternary main signal with the ternary main signal as a drive signal so that a level of the middle point 54 is positioned at the level of a bottom (lowermost point) 55 of the modulation characteristic curve, and supplies the amplitude signal to the external modulator 1.

When the drive signal is −1 or 1, light is output. When the drive signal is 0, light is not output, and thereby a signal light (1, 0, 1) having the same bit string for the amplitude as that of the binary main signal is obtained. Additionally the following configuration may be employed. That is, the level of the middle point of the drive signal may be positioned at a level of a predetermined position (for example, a top) of the modulation curve.

When misalignment (drift) between the level of the middle point 54 and the level of the bottom 55 of the drive signal 52 occurs, the bias adjusting unit 43 changes the bias level of the drive signal through the signal supply unit 41 such that the level of the middle point 54 and the level of the bottom 55 are aligned with each other.

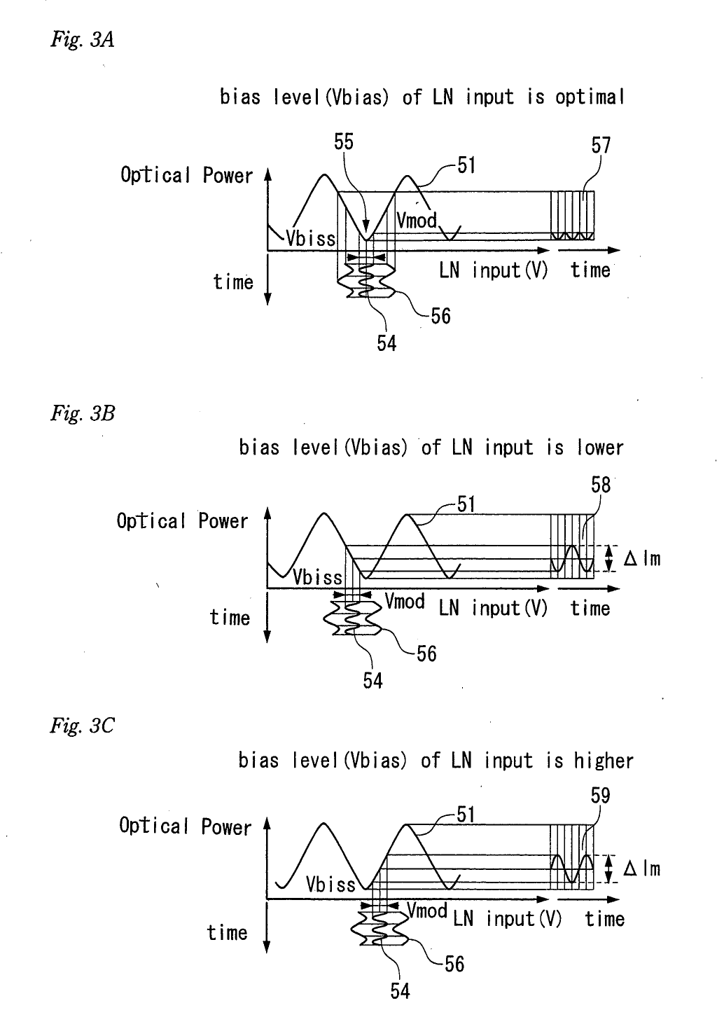

FIGS. 3A to 3C are explanatory diagrams of bias adjustment (ABC control) performed by the bias adjusting unit 43.

The bias adjusting unit 43 transmits a control signal having a predetermined frequency from the oscillator 44 to the signal supply unit 41 and supplies the control signal to the drive signal 52. In this manner, as shown in FIG. 3A, the level of the middle point 54 oscillates at the predetermined frequency.

The level of the middle point 54 is positioned at the level of the bottom 55. More specifically, when the signal is oscillated with the level of the bottom 55 as a center, sub-signal oscillation of an output light (signal light) 57 is small, as shown in FIG. 3A.

In contrast to this, when a level of the middle point 54 is lower than that of the bottom 55, control signal oscillation (sine-wave component) largely appears in an output light 58 as shown in FIG. 3B.

Also, when a level of the middle point 54 is higher than the level of the bottom 55, control signal oscillation largely appears in the output light 59 as shown in FIG. 3C. Here, the phases of output lights 58 and 59 are different depending on cases where the middle point 54 is lower than the bottom 55 or where the level of the middle point 54 is higher than the level of the bottom 55.

For the above reason, the bias adjusting unit 43 compares the feedback signal detected by the detection unit 6 with the control signal from the oscillator 44 and obtains a direction of misalignment of the level of the middle point (whether the level is higher or lower) and an amount of misalignment (amount of the level difference) on the basis of a phase difference and an amplitude of oscillation of the feedback signal. The bias adjusting unit 43 supplies the control signal (bias level controlling signal) corrected depending on whether the level is higher or lower and the amount of level to the signal supply unit 41. The bias adjusting unit 43 repeats the bias level adjustment for control to keep the middle point of the drive signal anytime at the level of a predetermined position (in this embodiment, the bottom) of the modulation curve of the external modulator 1.

The amplitude adjusting unit 42 of the modulator drive unit 4 modulates amplitude of the drive signal. More specifically, the amplitude adjusting unit 42 performs amplitude modulation for the drive signal using a sub-signal. For example, the amplitude adjusting unit 42 adjusts a gain of the signal supply unit 41 depending on the sub-signal.

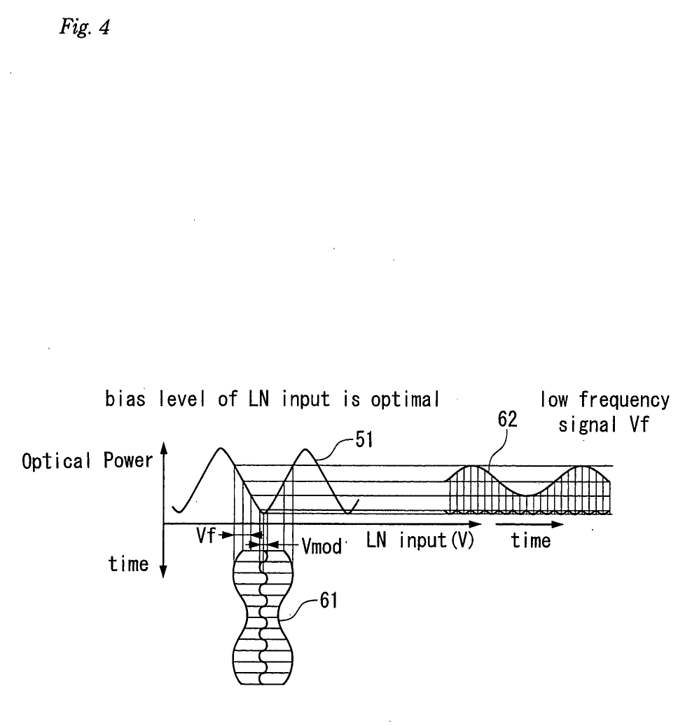

As shown in FIG. 4, a modulated drive signal 61 has a control signal component as level oscillation of the middle point and has a sub-signal component as a variation in amplitude.

The external modulator 1 performs signal modulation by the presence/absence of optical output depending on a main signal and changes an optical intensity. The external modulator 1 also performs sub-signal modulation and superposes the main signal and the sub-signal on a signal light 62. In this embodiment, the frequencies of the control signal and the sub-signal are set at different frequencies, so that the control signal component can be extracted by the bias adjusting unit 43.

For example, the speed of transitions of the main signal is set at 2.5 to 40 Gbps, the frequency of the control signal is set at 1000 to 2000 Hz, and the frequency of the sub-signal is set at 70 Hz to 300 Hz.

As described above, according to this embodiment, since the sub-signal is superposed by the external modulator, wavelength variation of a signal light is not caused and deterioration of transmission is reduced.

The present invention is not limited to the illustrated examples described above. The present invention can be variably changed without departing from the spirit and scope of the invention, as a matter of course.

What is claimed is:

1. A drive apparatus for an optical modulator comprising:
a signal supplying unit which supplies a ternary drive signal to the optical modulator;
an amplitude adjusting unit which modulates an amplitude of the ternary drive signal based on a sub-signal, the frequency of the sub-signal being different from the frequency of the ternary drive signal, and;
a detection unit which detects the intensity of an output light output from the optical modulator; wherein,
the amplitude adjusting unit changes the amplitude of the ternary drive signal based on a level of the sub-signal in the output of the detection unit.

2. The drive apparatus according to claim 1, further comprising a bias adjusting unit which changes a bias level of the ternary drive signal and modulates the bias level based on a control signal; wherein,
the bias adjusting units adjusts the bias level of the drive signal based on the level of the control signal in the output of the detection unit, and,
the bias adjusting units adjusts the bias level of the ternary drive signal such that the level of the middle point of the ternary drive signal is positioned at the level of the bottom or the top of the modulation curve of the optical modulator.

3. An optical modulator driving method comprising:
supplying a ternary drive signal to the optical modulator;
modulating an amplitude of the ternary drive signal by a sub-signal, the frequency of the sub-signal being different from the ternary drive signal;
detecting the intensity of the output light from the optical modulator; and,
adjusting the amplitude of the ternary drive signal based on the level of the sub-signal of the detected intensity of the output light

4. The optical modulator drive method according to claim 3, further comprising: modulating a bias level of the ternary drive signal by a control signal;
adjusting the bias level of the ternary drive signal based on the level of the control signal of the detected intensity of the output light; and,
adjusting the bias level of the ternary drive signal such that the level of the middle point of the ternary drive signal is positioned at a level of the bottom or the top of the modulation curve of the optical modulator.

5. An optical apparatus comprising:
a light source;
an optical modulator modulating a light output from the light source;
a signal supplying unit which supplies a ternary drive signal to the modulator;
an amplitude adjusting unit which modulates an amplitude of the ternary drive signal by a sub-signal, the frequency of the sub-signal being different from the ternary drive signal,
a detection unit which detects the intensity of the output light of the optical modulator; wherein,
the amplitude adjusting unit changes the amplitude of the ternary drive signal based on the level of the sub-signal in the output of the detection unit.

6. The optical apparatus according to claim 5, further comprising: a bias adjusting unit which changes the bias level of the ternary drive signal and modulates the bias level by a control signal; wherein,
the bias adjusting units adjusts the bias level of the ternary drive signal based on the level of the sub-signal in the output of the detection unit, and,
the bias adjusting units adjusts the bias level of the ternary drive signal such that the level of the middle point of the ternary drive signal is positioned at the level of the bottom or the top of the modulation curve of the optical modulator.
